(19) United States
(12) Patent Application Publication
(10) Pub. No.: US 2005/0246195 A1
(43) Pub. Date: Nov. 3, 2005

(54) System and method for developing and commercializing technology

(76) Inventors: Mark F. Smith, Amelia, OH (US); David J. Novak, Cincinnati, OH (US)

Correspondence Address: Mark F. Smith, 905 Ohio Pike, Cinicinnati, OH, 45245, US

(21) Appl. No.: 11/104,085

(22) Filed: Apr. 12, 2005

Related U.S. Application Data
(60) Provisional application No. 60/561,455, filed on Apr. 12, 2004.

(51) Int. Cl. G06F 17/60

(52) U.S. Cl. 705/1; 705/7

(57) ABSTRACT

A method and system of identifying research opportunities, organizing research programs to develop specific technology, organizing research funding activities, monitoring the progress of a research project, creating innovations and proving an effective commercialization program for the developed technology.

### BACKGROUND OF THE INVENTION

The present invention is a system and method of developing and commercializing technology, and more particularly, a system and method for developing and commercializing technology developed at a research organization.

Managing a business or an organization in a manner that creates long term value is a complex activity. Further, every business or organization has limited resources. Consequently, the need for businesses to accurately monitor their costs and justify resource allocation to achieve specified research and development outcomes in a future calendar time period (e.g., financial quarters) is critical to long term success. Unfortunately, the task of organizing business information to determine proper resource allocation is often time consuming and troublesome. In addition, it is often difficult or impossible for business managers to properly use this information to make accurate and appropriate research and development decisions.

Research organizations, such as universities, government laboratories, and private corporations, often have numerous research departments dedicated to the development of new products. Such departments are typically organized into smaller departments each responsible for separate research projects. As research organizations enlarge, such as through acquisitions and mergers, communication between the various research departments often fail. This breakdown in communication often leads to duplication of research effort resulting in significant increases in research costs thereby placing increased demand on limited resource allocations.

As state and federal funding of academic institutions and government research laboratories decreases and corporate competition increases, such organizations look towards commercializing advancement in research and technology as a means to offset the decrease in funding. Further, as state economies shift from businesses that depend on natural resources, semi-skilled workers, and mass production to an economy driven by higher education and technology, the need for research institutions to transfer technology into the commercial sector significantly increases.

Research organizations, as illustrated in FIG. 1, are typically organized such that specific projects are first proposed and identified and then are either directly funded or are funded through research grants, investors, or other forms of funding. Once funding has been obtained, researchers begin to conduct the proposed research and develop the desired technology. Once the technology has been developed it must then be commercialized. Unfortunately, technology that has been developed, such as in a research laboratory, often has no practical commercial application, or cannot be utilized due to legal concerns, or there is no mechanism in place to reach the commercial market.

Accordingly, a need exists for a system and method of identifying research opportunities, organizing research programs to develop needed technology, optimizing research funding activities, monitoring the progress of a research project, creating innovations and providing an effective commercialization program for the developed technology. A further need is for an effective system and method that will maximize the value of a business, the potential value of the developed technology, and maximize an organizations return on investment.

### SUMMARY OF THE INVENTION

The present invention provides a method and a system of developing and commercializing technology, and more particularly, a system and method for optimizing the development and the commercialization of technology developed by an organization. In a preferred embodiment of the invention the method identifies all proposed projects under consideration and/or active projects within an organization and examining each proposed project to determine if such projects may be related to other proposed, current projects, or existing portfolio technologies. In the event that there are related projects, such projects are reviewed to minimize the likelihood of any duplication of effort or resources. Proposed projects are also reviewed, analyzed, mapped, and assessed for commercialization potential relative to other populations, communities and functional groups.

In another preferred embodiment of the invention, the method and system operate to enhance the ability of various functional units within a functional group to work together to develop and commercialize technology.

In another preferred embodiment of the invention, the method and system operate to enhance the ability of various functional groups within a community to work together to develop and commercialize technology.

In another preferred embodiment of the invention, the method and system operate to enhance the ability of various communities within a population to work together to develop and commercialize technology.

In another preferred embodiment of the invention, the method and system operate to enhance the ability of various populations within a universe to work together to develop and commercialize technology.

In a preferred embodiment of the invention, the system effective for allowing organizations to collaborate with improved communication to produce a higher quality end product while minimizing development time and resources. Specifically, in a preferred embodiment of the invention, a software system is incorporated for use in managing a project and providing a communication mechanism across organizations or geographic locations where work is being performed.

In another preferred embodiment of the invention, the software system permits organizations to interactively work together to create and validate program tasks and requirements.

In another preferred embodiment of the invention, the software system enables organizations to work together on an ongoing basis throughout the project to define program tasks and requirements.

In another preferred embodiment of the invention, the system software enables end users to interactively work with organizations working on the project on an ongoing basis to ensure a viable end product that maximizes commercialization potential.

In another preferred embodiment of the invention, the validation of each task and requirement is done by participating organizations promptly after creation.

In another preferred embodiment of the invention, the software system further comprises means for modifying a task or requirement by participating team members.

In another preferred embodiment of the invention, the team members work on an ongoing basis throughout the project to identify potential commercialization opportunities and to develop commercialization programs or organizations that will maximize the desired returns.

In another preferred embodiment of the invention, the system software enables team members to work together on an ongoing basis throughout the project to identify technology that has been developed and to ensure that such technology is protected.

In another preferred embodiment of the invention, the system software enables team members to work together on an ongoing basis throughout the project to identify technology owned by others that would hinder or prevent commercialization of technology being developed.

In another preferred embodiment of the invention, the system includes a commercialization system whereby research projects that are ongoing are identified and summarized to permit potential end users to obtain information and evaluate such projects.

In another preferred embodiment of the invention, the commercialization system includes means for identifying technology available for licensing or sale whereby potential end users can review information concerning such technology.

In another preferred embodiment of the invention, the commercialization system includes Internet means whereby technology available for licensing or sale can be reviewed by potential end users.

In another preferred embodiment of the invention, research projects are identified, funded, bundled, and commercialized.

Other embodiments and advantages of the invention will be apparent from the following description, the accompanying, drawings, and the appended claims.

### BRIEF DESCRIPTION OF THE DRAWINGS

To provide a more complete understanding of the present invention and further features and advantages thereof, reference is now made to the following description taken in conjunction with the accompanying drawings, in which:

FIG. 1 is a diagrammatic representation of the prior art process of research and commercialization system typically utilized by research organizations;

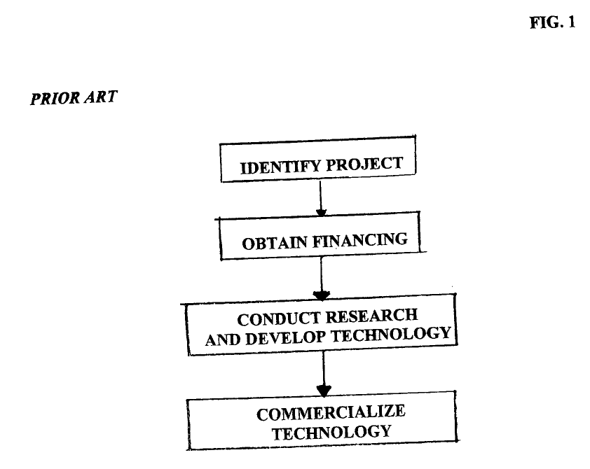

FIG. 2 is a diagrammatic representation of a community of the present application comprising at least one functional group;

FIG. 3 is a diagrammatic representation of a functional group of the present application comprising at least one functional unit;

FIG. 4 is a diagrammatic representation of a community of the present application comprising a variety of specialized functional groups;

FIG. 5 is a diagrammatic representation of a population of the present application comprising at least one community;

FIG. 6 is a diagrammatic representation of the universe of the present application comprising at least one population;

FIG. 7 is a diagrammatic representation illustrating the process of the subject application for developing and commercializing technology developed by a research organization;

FIG. 8 is a diagrammatic representation of an example population utilizing the method and system of the present application;

FIG. 9 is a diagrammatic representation of a typical legal functional group of the present application comprising a variety of functional units;

FIG. 10 is a diagrammatic representation of the computer system for operating the system software of the present application;

FIG. 11 is a diagrammatic representation of the structured methodology and design of the system software for developing and commercializing technology;

FIG. 12 is a flow diagram illustrating the general functional steps of the requirements module of the system software of FIG. 11;

FIG. 13 is a diagrammatic representation of the computer system for disseminating and communicating with the public information concerning projects and developed technology; and

FIG. 14 is a diagrammatic representation of a web page for use with the computer system of FIG. 13 whereby the public and receive information and contact subscribers or members of the system concerning projects and developed technology.

### DETAILED DESCRIPTION THE OF INVENTION

The present invention provides a system and method of developing and commercializing technology, and more particularly, a system and method for developing and commercializing technology developed by a research organization. In describing the preferred embodiments of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose.

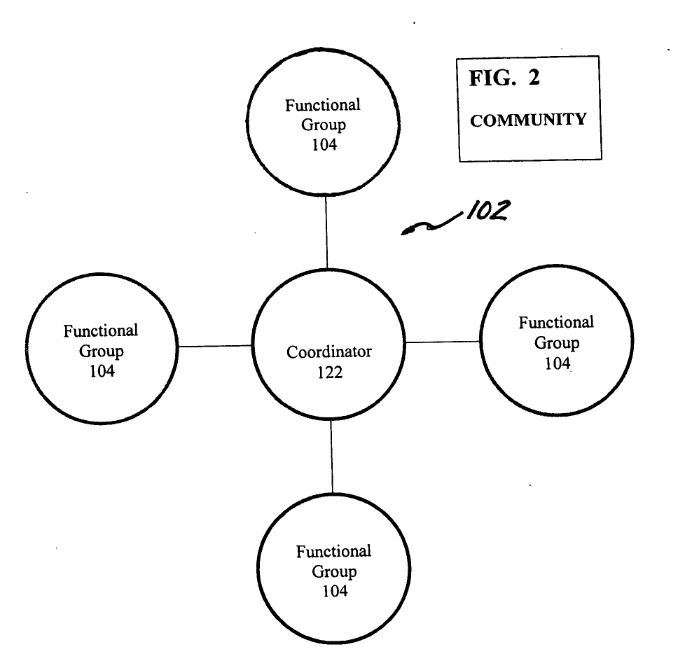

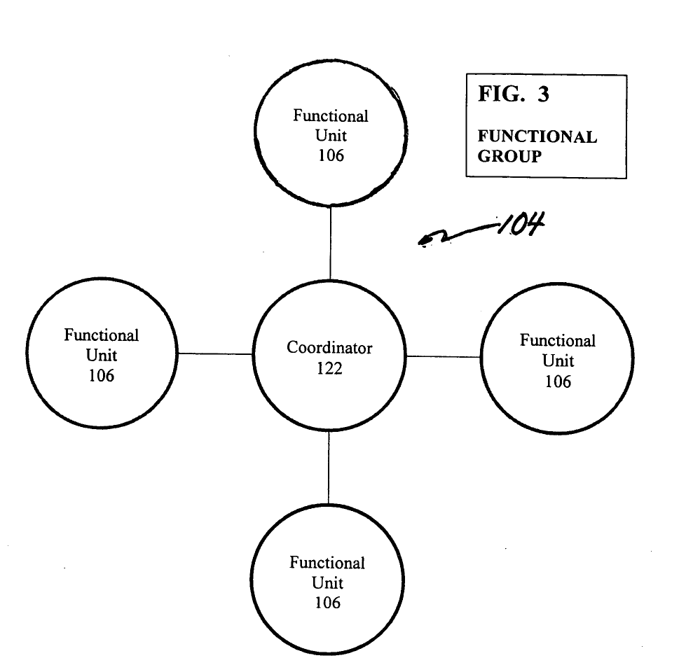

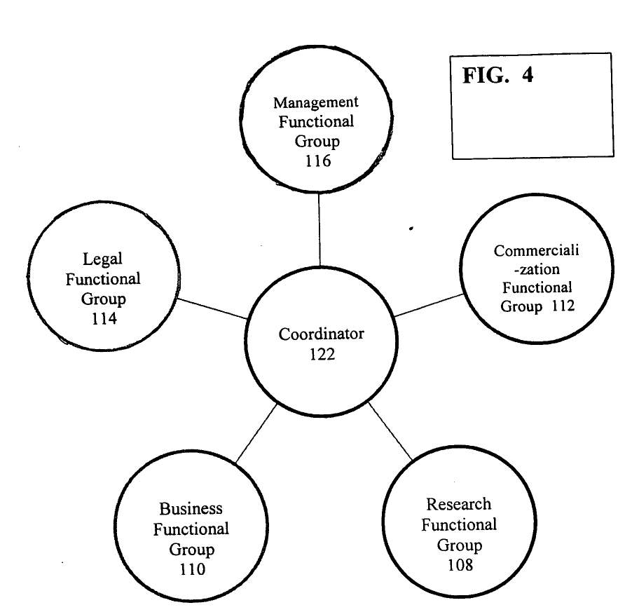

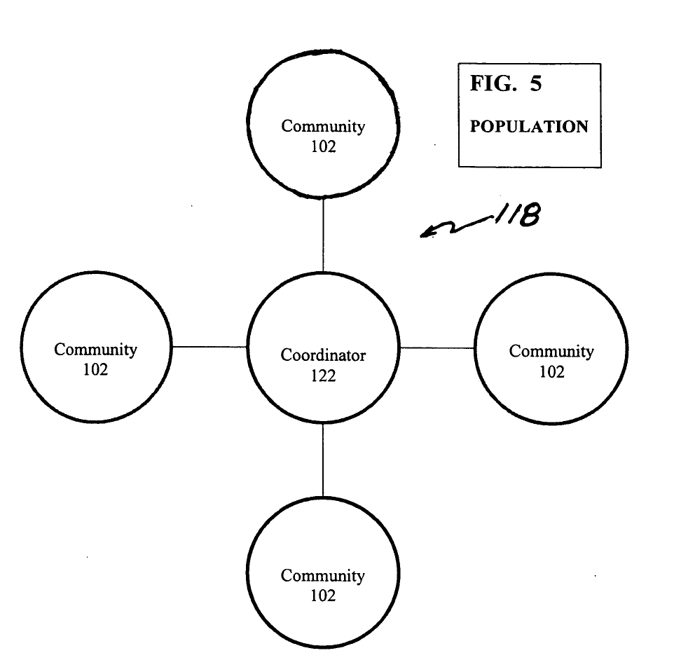

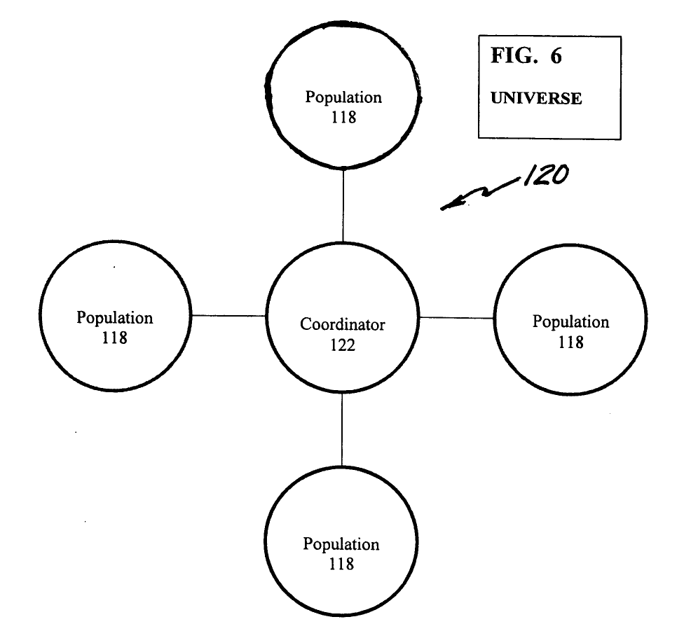

Referring to FIGS. 2 through 6, diagrammatic representations are provided illustrating a portion of the system 100 of the subject application for developing and commercializing technology developed by a research organization. As shown, a community 102 is defined herein as comprising a plurality of functional groups 104 each having one or more functional units 106 (FIG. 3). As used herein and illustrated in FIGS. 3 and 4, a functional group 104 can include groups responsible for a wide variety of operations and can comprise research functional groups 108 each having one or more functional units 106 doing research and development operations, business functional groups 110 each having one or more functional units 106 performing business operations, commercialization functional groups 112 each having one or more functional units 106 performing commercialization operations, legal functional groups 114 each having one or more functional units 106 performing legal operations, and management functional groups 116 each having one or more functional units each performing management operations. As shown in FIGS. 5 and 6, a population 118 as used herein, comprises more than one community 102 and the universe 120 as used herein is defined as comprising one or more populations 118.

In a preferred embodiment of the invention, the system 100 operates such that each functional group 104 within a community 102 work and communicate together on an ongoing and real time basis to organize, develop, perform a research program and to commercialize the results of the research program. In order to better understand how the functional groups 104 above described interrelate; the operation of the functional groups 104 will now be described.

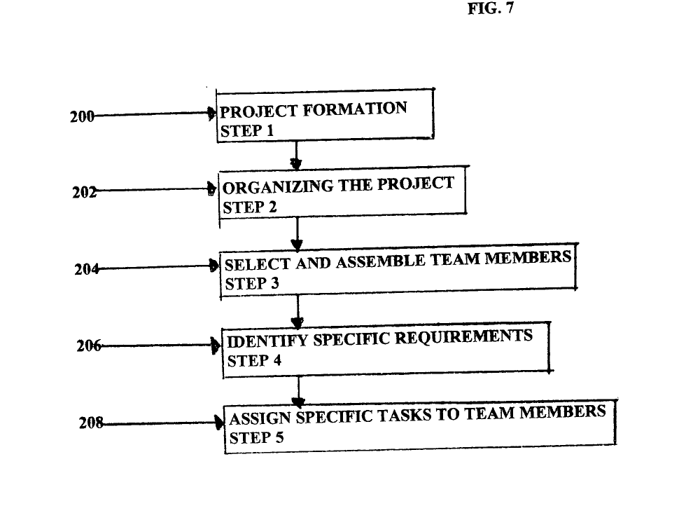

Referring to FIGS. 4 and 7, a project is first proposed (step 1) 200 and submitted to a coordinator 122. Typically, the project is identified within a given community 102 (FIG. 2), it being understood however that the project could also be developed and/or worked within a universe 120 (FIG. 6), population 118 (FIG. 5), community 102 (FIG. 2), and/or functional group 104 (FIG. 3), generically the designated entities shall be referred to herein individually as a “team member”. The project may also be a subproject within a larger project. The coordinator 122 is responsible for organizing the project (step 2) 202 and operates to promote communication between the team members (i.e. functional units 106 (FIG. 3), or between functional groups 104 (FIG. 2), or between communities 102 (FIG. 5), or between populations 118 (FIG. 6)) and further acts to coordinate and maintain communication within the research organization. The coordinator 122 further operates to select and assemble (step 3) 204 the desired team members who will work together on the project and will work to identify specific requirements for the project (step 4) 206 and assign specific tasks (step 5) 208 to each selected team member.

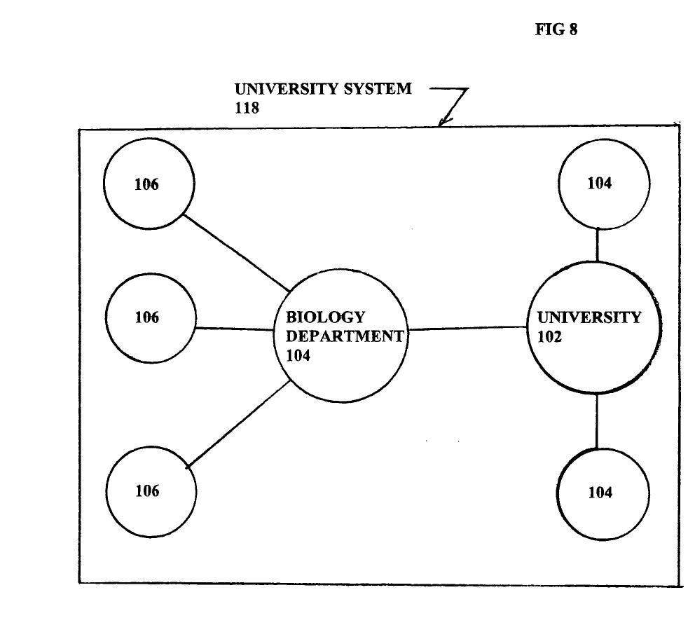

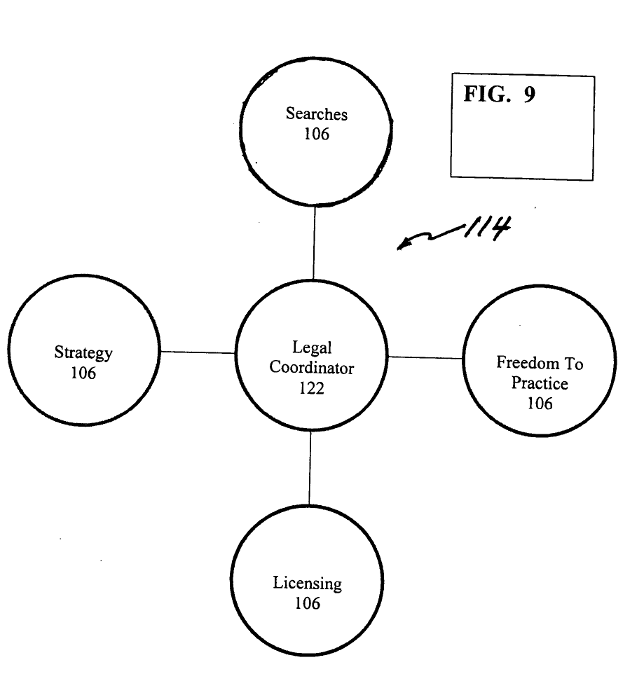

For illustration purposes, in a particular example as illustrated in FIGS. 7 and 8, the population 118 is a university system. A researcher, representing a functional unit 106, is a member of a research functional group 104, such as a biology department operating as part of a community 102, and a particular university. If the researcher makes a proposal for a new concept that he/she believes could lead to long-term benefits, the researcher can submit the proposal into the system, such as the intellectual property department of the university. Under the method and system of the present invention, the researcher would submit the proposal by entering the proposal, together with preliminary information and background material using the method and the system of the subject application. The method and the system of the present application will operate to circulate the proposal to other functional units 106 within the particular functional group 104 for comment. Assuming that the proposal appears to be viable, the proposal would be submitted to a coordinator 122 to form the project (step 1) 200 who will then organize the project (step 2) 202 and will select and assemble participating team members (step 3) 204. For example, the coordinator 122 may determine that the certain desired team members, in this example the team members being functional groups 104, may include a research functional group 108, a business functional group 110, a commercialization functional group 112, and legal functional group 114 (FIG. 4). Each functional group 104 then determines which functional units 106 are required for the project and develops requirements (step 4) 206 for the project and assigns specific tasks (step 5) 208 to team members. The selected team members then interact together in real time to ensure that wasted or duplicated effort are minimized. In the proposed example, as illustrated in FIG. 9, the legal functional group 114 typically has various legal functional units 106 that perform varies activities such as conducting intellectual property searches, such as patent, trademark and/or copyright searches, to ensure that the results of the research and development project can be protected; freedom to practice studies to determine if the research and products developed can be utilized or practiced; intellectual property strategies are developed and assessed; and licensing potential and needs are identified and assessed thus establishing that the final research and/or product may be commercialized. It should now be understood that the other functional groups 104, as shown in FIG. 4, such as the business functional group 110 will typically have various functional units 106. In the proposed example, the business functional group 110 may have various functional units performing business activities such as obtaining financing, constructing and overseeing budgets, and the like. Simultaneously, the commercialization functional group 112 may have various functional units 106 perform commercialization activities such as conducting market and valuation studies, advertising and promotional studies, and the like.

As each team member performs its activity of reviewing, researching and analyzing in performance of the project, information is continuously revised, updated and inputted into the system of the present application.

Further, it should now be apparent that team members working and communicating together in real time will operate to reduce duplication of effort and enhance commercialization of the final product. For example, if a team member operating in a legal functional group determines that the proposed project will result in an end product that may infringe a patent belonging to another, the team member can communicate such information to all of the other team members operating in other functional groups in the community. The team members can then work and communicate together to determine the best approach, such as modifying the research to design around the patent or obtain licensing before significant time and money has been expended on the project. It should now be apparent that under the system of the present application, team members working and communicating together on an on-going basis will increase the probability that specific risks will be identified at an early point in the project thereby allowing modifications of the project requirements to be done with the minimum effect to the project.

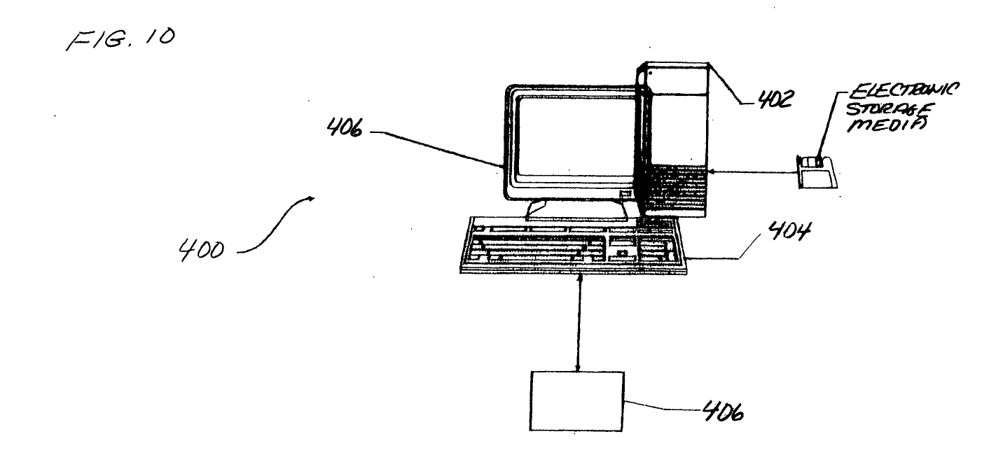

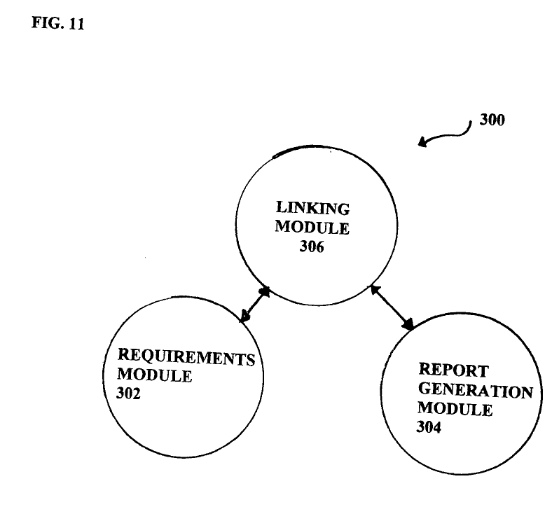

Referring to FIGS. 10 and 11, a preferred embodiment of the system preferably utilizes system software 300 for enhancing communication between various entities such as between communities 102 (FIG. 2), functional groups 104 (FIG. 3), functional units 106 (FIG. 3), and populations 118 (FIG. 6) and includes a computer system 400 for implementing the system software 300 (FIG. 11). The computer system 400 comprises a processor and a memory 402 that may be coupled to other devices, such as a suitable input device 404, like a keypad, touch screen, or any other suitable input device that can accept information, and one or more suitable output devices 406, such as a computer display, printer, projection device, and the like. It should be understood that the computer system 400 can include any combination of the above components, or any number of different components, peripherals, and other devices. Preferably, the computer system 400 operates under the control of an operating system, such as the WINDOWS™ operating system developed by Microsoft Corporation or the Macintosh™ operating system developed by Apple Computer Corporation. It should be understood, however, that other operating systems could be utilized to implement the system software 300 of the present invention.

The system software 300 is a computer-readable medium having computer-readable instructions for performing the method of the present invention. Preferably, the system software 300 is an interactive, menu and event driven system that uses prompt, dialog, and entry windows to guide a user to enter information. As used herein, the term “software” refers to any form of programmed machine-readable language or instructions (e.g., object code) that, when loaded or otherwise installed, provides operating instructions to a machine capable of reading those instructions, such as a computer. The system software 300 of the present invention can be stored or reside on, as well as be loaded or installed from, one or more floppy disks, CD ROM disks, hard disks or any other form of suitable non-volatile electronic storage media. The system software 300 can also be installed by downloading or other form of remote transmission, such as by using Local or Wide Area Network (LAN or WAN)-based, Internet-based, web-based or other remote downloading or transmission methods.

Referring to FIG. 11, a flowchart illustrating the structured methodology and design of the system software 300 of the present invention is shown. The system software 300 preferably comprises four modules including a requirements module 302, and a report generation module 304 and an integrated linking module 306 that provides a software link between the requirements module 302 and the report generation module 304 for generating project reports.

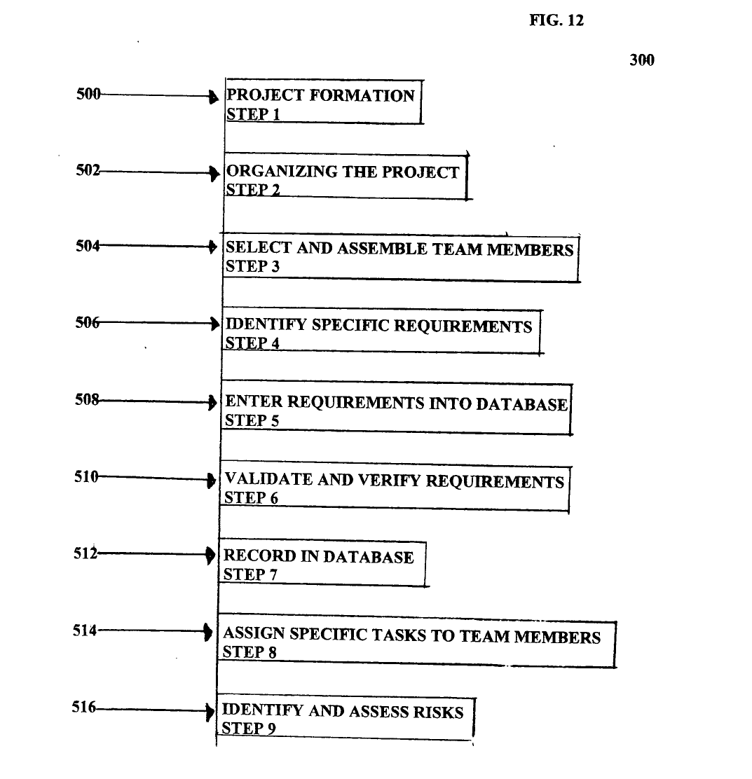

Referring to FIGS. 11 and 12, the requirements module 302 is shown whereby a project is first proposed and/or formed (step 1) 500 and a project is first created and identified. After the project has been identified, a coordinator is selected who operates to organize the project (step 2) 502 who determines and selects the appropriate team members (step 3) 504 who will work and communicate together to create and identify the appropriate requirements for the project (step 4) 506 which are then entered into a requirements and tasks database 308 (step 5) 408 within the processor and memory 402 of the computer system 400 by the coordinator who operates as the focal point for the formulation and communication of the specific requirements. As used herein, the term “requirements” refers to all of the requirements to be addressed by the technology to be developed.

Such requirements, may include, but are not limited to, operating parameters, dimensions, uses of the technology, government regulations, problems to be solved, etc. Once the requirements have been created (step 4) 506 and entered (step 5) 508, together with all pertinent historical documentation, each requirement is then validated and verified by participating team members (stop 6) 510 and then recorded in the requirements and tasks database (step 7) 512. It should be understood that the steps of identifying requirements (step 4) 506, entering the requirements (step 5) 508, validating and verifying the requirements (step 6) 510, and recording the verified requirements (step 7) 512 are accomplished in succession and in real-time. This real-time operation of creating and entering, verifying and validating, and recording of a requirement is essential to ensuring an accurate project specification from which the technology can be developed. The requirements are then transmitted during steps 506-510 to suitable output devices 406 (FIG. 10) through the Internet or by an Intranet system for exposure to all team members identified and entered into the requirements and tasks database 308 for their review and comment. In this way, all team members participate in creating a store of clear, concise, and mutually agreed upon set of requirements that will increase the likelihood of success of the project. This will result in minimizing the amount of rework typically associated with inaccurate requirements, or requirements that must change for various reasons, such as other similar projects being worked, intellectual property restrictions, changes in end users needs or wants, and the like.

Once the requirements have been determined and entered into the requirements and tasks database 308, specific tasks are then assigned to the team member (step 8) 514. The coordinator 122 who is responsible for the overall communication exchange between the team members and may also be responsible for the technical success of the project then records each task in the requirements and task database 308. After the requirements of the project have been identified and agreed to by the team members, project risks that may threaten the success of the project are identified and assessed (step 9) 416, for example, by a legal functional group, and recorded into a risk database 310 by the coordinator 122. These risks are also constrained and included or excluded based on input by other team members. The system software 300 also operates to prompt the coordinator to enter other initial information such as contact information and the like.

As previously described, team members work together to generate, exchange, categorize, and prioritize ideas, to formulate requirements and tasks that will fulfill the goals, objectives and scope of the project. It should be understood that the system software 300 (FIG. 11) can operate using remote input/output terminals that are linked together such as through the Internet to permit team members to communicate and provide input from numerous remote locations.

During step 506 requirements are created and entered by the coordinator who, in collaboration with other team members, records each requirement and pertinent historical documentation such as the requirement session (including date and time of each session) and participating team members (which as used herein include the team member originating the requirement and the team members that are participating in the requirements session) into the requirements database. It should be understood that in another preferred embodiment of the invention, additional information may be recorded, such as comments, summaries and conclusions. In another preferred embodiment of the invention, the requirement may also be ranked according to its importance in the project.

As shown in FIGS. 2 and 11, the requirements module 302 integrated with the report generation module 304. During step 6 510, after a requirement session has ended, the coordinator may direct the system software 300 to operate and publish the requirement to each team member using the report generation module 304, such as through the use of a suitable output device 406 (FIG. 10), such as by way of facsimile, hard copy, or other such means.

When a requirement is created and entered (step 5) 508, it is further characterized by its status in the overall project. This status of each requirement, might, for example, be that of “active,” “retired,” “pending,” “superceded,” or “comment.” A status indicator for example of “active” may identify a requirement that will be incorporated into the specification for implementation into the proposed project. A status indicator of “retired” may for example deem a requirement as being no longer valid and will not be incorporated into the project and will not be implemented. A status indicator of “pending” may deem that a requirement will not be incorporated into the project until an action item that is entered, recorded, and associated with the requirement has been accomplished. At that time the “pending” status indicator can be changed to “active” or “retired.” It should be understood that a requirement, once saved, is never modified. Instead, a copy is made of the requirement and changes are made to the copy and then it is saved as, for example, an “active” requirement, while the previous version of the requirement is given a status indicator of “superceded” and linked back to the new requirement that took its place, thereby providing traceability. Further, each superceded requirement is given a reason as to why it has been superceded. A status indicator of “comment” is given to a requirement that is really not a true requirement, but a comment on another requirement. The system software 300 (FIGS. 11 and 12) operates to permit team members to record comments about existing requirements. These comments are entered external to a requirements session. Subsequently, these comments are then addressed at the next requirement session, where their status may be changed to indicate the disposition deemed appropriate by the participating team members. The process of creating and entering, verifying and validating, and recording a requirement in real-time is then repeated until all of the requirements for the input session have been entered.

It should be understood, that this process of creating and entering, verifying and validating and recording a requirement in real time permits all of the team members to work together on a project and ensures that any risk or hindrance, such as the discovery of patents that may block or hinder the use of any developed product or technology, or changes that may affect the needs of the end user are quickly identified so that the project requirements can be modified to circumvent such hindrances or better satisfy the needs of the end user.

The method and system of the present invention enables all levels and entities therein to be involved in the project from concept to commercialization. The commercialization phase of the method and system of the subject invention utilizes the end user as the focus and the pathway for the developed technology and/or product, herein after referred to as the “innovation.” It should be understood that the pathway to the end user proceeds from the two-way communications of population to communities to functional groups and functional units. Each level directly interacts with the other levels through the aforementioned interactive system software. The method and system of the present invention permits real time communication that allows all team members to work collectively to arrive at decisions and buy-in as the innovation proceeds through the pipeline. This results in projects that come to fruition or that are killed before valuable resources are unnecessarily expended.

Referring to FIG. 3, the population, which may be variously defined as industry, university and/or government research lab, is positioned at the core location. In turn, all the satellite communities interact through the core, in real time, and are in direct communication at all times. At the top level, communications are presented in final form, providing the necessary and proper information to decision makers regarding all aspects of the innovation.

The same process and associated pathways, as described above, function at each descending level of the system and method. Accordingly, the same rules of procedure apply, but it is only a matter of the degree of information detail being exchanged between team members at each level. Altematively, this system and method could be viewed as several dimensions of interaction occurring simultaneously between and among functional units, functional groups, communities and populations; all of which are internal to the given core entity.

Upon innovation completion, the innovation is prepared for commercialization, the system and method pathway is directed towards the end user, who is the core and the focus of all efforts by the commercialization team. The method and system of the present application is designed to provide all team members with the benefit of and unparalleled opportunity to begin to develop a commercialization strategy from the time of the formation of the initial concept and continuing through project completion and the production of a final product. This advantage allows the inventor/organization to know far in advance where the innovation may best be applied and to identify the best revenue producing commercialization opportunities; again, expediting the commercialization process. This methodology also allows investors, purchasers, licensees, and the like to become involved in a much earlier stage of the product timeline/pipeline, if and when the research organization deems this appropriate.

The system and method also provides a specific pathway to commercialization, that may be customized to meet the particular needs of any given population, community and/or functional group and comprises various operations that may include:

IP Portfolio Analysis—In this operation a review all its existing intellectual property is performed to determine how the new innovation/technology fits into an organizations current holdings, i.e. is it directly related to its core competency, or a non-core competency.

Strategy Development—In this operation new technology is aligned with the organizations core competency technologies to determine bundling or stand alone opportunities. In addition, the competitive landscape is analyzed and the past, present and projected near future of the technology is mapped by extensive research into prior art and the organizations involved in said prior art. Potential competition, potential licensees, buyers and donees for the technology are identified.

Intellectual Property Strategy Implementation—In this operation, patent and other intellectual property are reviewed for filing as well as establishing of patent clusters and brackets to provide the technology additional protection, if applicable. The operation also provides for additional research and development with the expectation of other patents being filed directly complementing this new technology.

Intellectual Property Commercialization—Based upon any prior art research, and other market studies, potential licensees are targeted. Each target is defined by the particular application within its industry or sector. With this information various valuation methods are used to derive an appropriate value, which will be used in future technology transfer negotiations. Simultaneously, marketing and licensing strategies are further developed. In addition, a special commercialization team is selected, composed of all relevant team members in the project pathway. The commercialization team will prepare the presentation for demonstration to potential customers.

Intellectual Property Maintenance, Management & Administration—The system and method of the present application serves to devise a record keeping system to ensure timely and proper royalty payments and reporting requirements, both internal to the organization and external, i.e. licensees etc. The proper personnel are then assigned to maintain and monitor the system.

Program Review for Effectiveness, Efficiency and Expenses—The system and method dictates that each of the above operations are analyzed quarterly to determine its particular and overall effectiveness, efficiency and associated costs of the project. The results are used to continuously improve the methodology and determine best practices for the organization, and if need be to amend and re-deploy research and development resources.

One primary objective of the system and method is to optimize research and development expenditures, and maximize the value of the innovation developed, by ensuring a direct pathway to the commercial market, i.e. concept to commercialization.

To illustrate the system and method described above, it is best to site a specific example of the implementation and execution of the system and method. For illustration purposes, it will be assumed that the population is a university system, (vs. Industry or Government Lab). A researcher, representing a functional unit, is a member of a functional group, in this example, an engineering department which is part of a community, and in this example, a university. The university is also a member of the population of universities. The researcher believes that he/she has a concept that could lead to long-term benefits to the universe (i.e. all end-users).

Utilizing the method and system of the present invention, the researcher would submit his/her concept, along with preliminary information and background research and based upon his/her best efforts submit a business case for his proposal. The entire proposal would then be circulated to the other functional units within the functional group, such as by use of the system software previously described herein, for comment.

Assuming a basic consensus on the merits, the proposal would then be sent to the next level for consideration, such as to other functional groups within the community. The process of circulation, analysis and comment is repeated at this level and a determination is made to pursue the concept. If so, the project coordinator selects all desirable functional groups as well as a representative from each functional group.

It should now be understood that while the researcher may drive the project, he/she receives real time assistance and input from all team members. It should also be understood that the method and system of the present invention is an ongoing, robust and interactive process resulting in project requirements that are constantly being revised and developed as the project proceeds through the development and commercialization process.

Assuming the project is determined viable by all of the team members, it can then be circulated, such as by using the system software via the Internet, to other communities, such as in the above example within the university population. This circulation among the various communities will serve to prevent or reduce the likelihood that there is no redundancy, overlap or conflict within the population. It should also now be understood that such communication will also provide the added benefit of identifying and finding complementary technologies being developed in other communities. In addition, the method and system described herein provides a mechanism to obtain further input and accordingly, the requirements of the project may be properly and timely revised and adapted.

Another feature of the system and method herein described allows the parties involved in the financial allocation process, and who may have to make financial decisions involving various projects; i.e. projects competing for the same financial funding, to have the necessary information to best determine and optimize resource allocation.

Assuming no other redundant technologies are unveiled, the project proceeds to fruition and thereafter, commercialization, i.e. finding the end user. The commercialization process involves a step-by-step program broadly defined as initiation, negotiation and consummation.

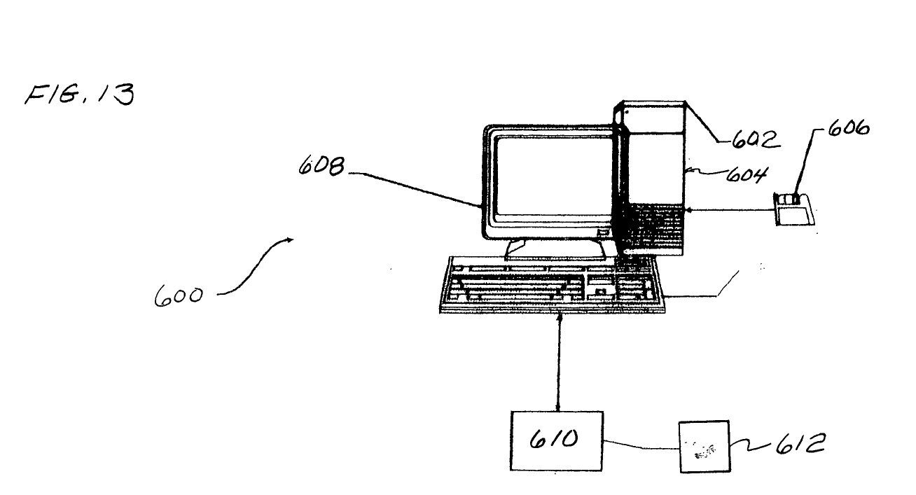

In another preferred embodiment of the invention, the system further comprises means for data collection, evaluation, information generation, and presentation. Generally, the system is a computer based information, advertising and marketing system having many end user computers and at least one information server apparatus. Referring to FIG. 13, the information server 600 includes a central processing unit 602, primary memory 604 (i.e. random access memory) and secondary memory 606 (such as disk storage) for use as an information database, a user interface 608, and an Internet interface 610 for communication with end users computers 612 via the Internet. An information manager, not shown, using the user interface 608 is responsible for editing and formatting information into a form suitable to disseminate the information to the end users. Such information is then stored in the secondary memory 606 in the information server 600.

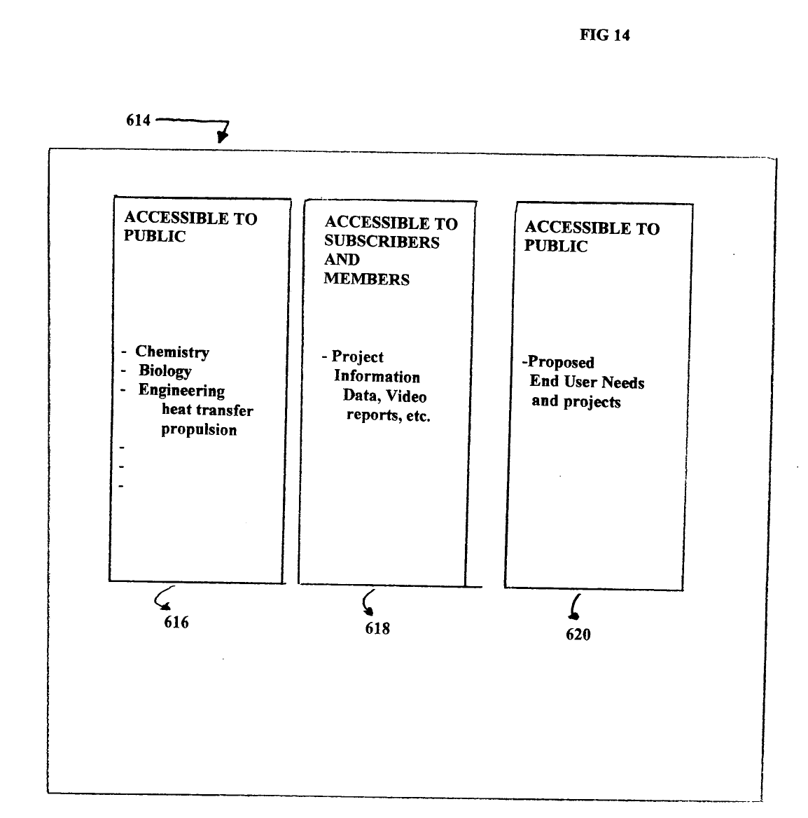

Referring to FIGS. 13 and 14, the methodology of the web page 614 of the present invention is illustrated. The information manager hosts the web page 614 of the subject application on the information server 600 which is accessible to the public through the Internet. Preferably, the web page 614 is formed having three sections. The first section 616 is accessible to the public and allows the user to identify specific information sought to be reviewed; the second section 618 is accessible to subscribers or members of the system and allows subscribers to input information into the secondary memory 606; and the third section 620 is also accessible to the public and allows the public to input various wants and needs into the secondary memory 606 and allows subscribers or members of the system access to such information. It should be understood that information contained within the secondary memory 606 is provided using security features that are typical in the art employed to ensure confidentiality and/or tampering or corruption of the data.

As a project progresses, subscribers or members can input information concerning the project, including information concerning developed technology, can be submitted into the secondary memory 606. Such information can be in the form of written descriptions, photographs, or video that can show or otherwise disclose information concerning the project and/or developed technology. End users can then search the secondary memory 606 and review the inputted information. It should be understood that the first section of the web page 614 can be conventionally operated such that end users can search the information contained in the secondary memory 606 by keep words, by topic or subject matter, or any other conventional search methods. It should also be understood, that while end uses may include potential investors, licensees, or buyers, an end user may also include others looking for complimentary technologies or those working on other similar projects.

Subscribers or members of the system may also amend or update information relating to their project using the second section 618 of the web page 614 and are assigned a log-in identifier that can be used to gain access to the system. The third section 620 is accessible to the public and allows the public to input various wants and needs into the secondary memory 606 and allows subscribers or members of the system access to such information. End users having proposals for work or projects can solicit requests for information or request interested parties to contact them regarding such work or projects. It should be understood that the ability of the system to allow the public to solicit for team members enhances a researcher's ability to develop technology that will be utilized by end users.

Accordingly, the method and system of the present application operates to identify research opportunities, organizes research programs to develop needed technology, optimizes research funding activities, monitors the progress of a research project, creates innovations and provides an effective commercialization program for the developed technology. The method and system further provides means for maximizing the value of a business, the potential value of the developed technology, and maximizes an organizations return on investment.

1. A method for developing and commercializing technology comprising the steps of:
identifying all proposed projects under consideration within an organization;
examining each proposed project to determine if such projects may be related to other proposed, current projects, or existing portfolio technologies;
reviewing such projects to minimize the likelihood of any duplication of effort or resources; and
reviewing, analyzing, mapping and assessing each project for commercialization relative to other populations, communities and functional groups.

2. The method of claim 1 wherein the step of reviewing, analyzing, mapping and assessing each project is performed by a community comprising a plurality of functional groups.

3. The method of claim 2 wherein the functional groups work and communicate together on an ongoing and real time basis.

4. A method for developing and commercializing technology comprising the steps of:
proposing a project and submitting the project to a coordinator;
organizing the project and selecting the team members who will work together on the project;
identifying specific requirements for the project and assign specific tasks to each team member;
revising and updating the specific requirements based on the results of the tasks assigned to each task member.

5. The method of claim 4 wherein the team members comprise organizational groups that are selected from the group consisting of research organizations, business organizations, legal organizations, and commercialization organizations.

6. The method of claim 4 wherein the organizations may comprise communities, functional groups, functional units and populations.

7. The method of claim 4 further comprising the step of using a software system for managing the project and providing a communication mechanism across team members.

8. The method of claim 6 wherein the software system permits team members to interactively work together to create and validate program tasks and requirements.

9. The method of claim 6 wherein the validation of each task and requirement is done by participating organizations promptly after creation.

10. The method of claim 6 wherein the software system further comprises means for modifying a task or requirement by participating team members.

11. The method of claim 6 further comprising the step of identifying potential commercialization opportunities and develop commercialization programs to maximize the desired returns.

12. The method of claim 6 wherein the system software operates to track technology that has been developed to ensure that such technology is protected.

13. The method of claim 6 wherein the system software operates to identify and track technology owned by others that would hinder or prevent commercialization of technology being developed.

14. The method of claim 6 wherein the system software operates to allow potential end users to obtain information and evaluate such projects.

15. A computer assisted method comprising the steps of:
inputting data to create and identify a project;
selecting a coordinator and team members;
creating and identifying appropriate requirements for said project and entering same into a requirements and tasks database;
validating and verifying said requirements by said team members and recording same into said requirements and tasks database;
assigning specific tasks to each team member; and
identifying project risks.

16. The computer assisted method of claim 15 wherein the steps of creating and identifying appropriate requirements and validating and verifying said requirements are performed in succession and in real-time.

17. A method of commercialization comprising:
a web page having a first section, a second section and a third section;
said first section being accessible to the public and operates to allow the user to identify specific information sought to be reviewed;
said second section being accessible to subscribers of the system and operates to allow said subscribers to input information into a secondary memory;
said third section being accessible to the public and operates to allow the public to input various wants and needs into said secondary memory and allows subscribers to access said wants and needs;
wherein said first section includes information concerning certain projects and technology;
wherein said second section includes information concerning certain projects and technology; and
wherein said third section includes information concerning certain projects and technology.

18. The method of commercialization of claim 17 wherein said first section includes information about technology available for commercialization.

19. The method of commercialization of claim 17 wherein said second section includes information relating to participating in projects.

20. The method of commercialization of claim 17 wherein said third section includes information for those seeking to participate in a project.
